(19) United States
(12) Patent Application Publication
(10) Pub. No.: US 2025/0214886 A1
(43) Pub. Date: Jul. 3, 2025

(54) GLASS FIBER AND METHOD FOR PRODUCING THE SAME

(71) Applicant: NAN YA PLASTICS CORPORATION, TAIPEI (TW)

(72) Inventors: TE-CHAO LIAO, TAIPEI (TW); WEI-SHENG CHENG, TAIPEI (TW); CHIA-SHAN CHANG, TAIPEI (TW); CHIA-CHEN SU, TAIPEI (TW)

(21) Appl. No.: 18/626,487

(22) Filed: Apr. 4, 2024

(30) Foreign Application Priority Data
Dec. 27, 2023 (TW) 112150984

(51) Int. Cl. C03C 14/00; C01G 41/00; C03B 37/02; C03C 13/00

(52) U.S. Cl. CPC C03C 14/004; C01G 41/00; C03B 37/02; C03C 13/00; C01P 2004/80; C03C 2213/00; C03C 2214/05; C03C 2214/30

(57) ABSTRACT

A glass fiber and a method for producing the same are provided. The method includes: dissolving a tungsten compound into a first organic solution to form a tungsten compound sol; adding a sulfur source into the tungsten compound sol and stirring the sulfur source and the tungsten compound sol to form a tungsten sulfide gel; placing the tungsten sulfide gel in an environment having a temperature of between 600° C. and 1,200° C. for 4 hours to 6 hours to form tungsten sulfide powder; covering the tungsten sulfide powder on a plurality of surfaces of inorganic powder to form modified inorganic powder, mixing the modified inorganic powder into a glass raw material that is in a molten state; and drawing the glass raw material mixed with the modified inorganic particles to form into a plurality of glass fibers.

### CROSS-REFERENCE TO RELATED PATENT APPLICATION

This application claims the benefit of priority to Taiwan Patent Application No. 112150984, filed on Dec. 27, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a glass fiber and a method for producing the same, and more particularly to a glass fiber including tungsten sulfide and method for producing the same.

### BACKGROUND OF THE DISCLOSURE

In a conventional method for producing glass fibers, since a sliding property of the glass fibers are not good enough, the glass fibers can easily break during a drawing process.

### SUMMARY OF THE DISCLOSURE

In response to the above-referenced technical inadequacy, the present disclosure provides a glass fiber and a method for producing the same to effectively improve on problems with a conventional glass fiber which easily breaks during a drawing process.

In order to solve the above-mentioned problems, one of the technical aspects adopted by the present disclosure is to provide a method for producing glass fibers. The method includes a tungsten compound sol forming process, a tungsten sulfide gel forming process, a heat treating process, a covering process, a mixing process, and a drawing process. The tungsten compound sol forming process is implemented by dissolving a tungsten compound into a first organic solution to form a tungsten compound sol. The tungsten sulfide gel forming process is implemented by adding a sulfur source into the tungsten compound sol and stirring the sulfur source and the tungsten compound sol to form a tungsten sulfide gel. The heat treating process is implemented by placing the tungsten sulfide gel in an environment having a temperature of between 600° C. and 1,200° C. for 4 hours to 6 hours to form tungsten sulfide powder. The covering process is implemented by covering the tungsten sulfide powder on a plurality of surfaces of inorganic powder to form modified inorganic powder. Based on a total weight of the modified inorganic powder being 100 wt %, a content of the tungsten sulfide powder is 0.01 wt % to 5 wt %. The mixing process is implemented by mixing the modified inorganic powder into a glass raw material that is in a molten state. The drawing process is implemented by drawing the glass raw material mixed with the modified inorganic particles to form into a plurality of glass fibers.

In one of the possible or preferred embodiments, after the tungsten sulfide gel forming process and before the heat treating process, the method further includes a washing and drying process implemented by washing and filtering the tungsten sulfide gel for a plurality of times and then drying the tungsten sulfide gel.

In one of the possible or preferred embodiments, in the covering process, the tungsten sulfide powder are dispersed in a second inorganic solution, then the tungsten sulfide powder and the second organic solution are added into the inorganic powder, and the tungsten sulfide powder, the second organic solution, and the inorganic powder are stirred, such that the tungsten sulfide powder cover onto the inorganic powder to form the modified organic powder.

In one of the possible or preferred embodiments, the tungsten compound is tungsten hexachloride.

In one of the possible or preferred embodiments, a weight ratio between the tungsten compound and the sulfur source is between 5:1 and 8:1.

In one of the possible or preferred embodiments, the inorganic powder is at least one from the group consisting of silicon dioxide, titanium dioxide, aluminum hydroxide, magnesium hydroxide, calcium carbonate, aluminum oxide, and calcined kaolin.

In one of the possible or preferred embodiments, a particle size of the inorganic powder is within a range from 0.01 micrometers to 50 micrometers.

In one of the possible or preferred embodiments, based on a total weight of each of the glass fibers being 100 wt %, a content of the modified inorganic powder is 0.1 wt % to 5 wt %.

In one of the possible or preferred embodiments, each of the glass fibers has a maximum static friction coefficient within a range from 0.39 to 0.48.

In order to solve the above-mentioned problems, another one of the technical aspects adopted by the present disclosure is to provide a glass fiber. The glass fiber includes a glass raw material and a plurality of modified inorganic particles. The modified inorganic particles are dispersed in the glass raw material. Each of the modified inorganic particles includes a inorganic particles and tungsten sulfide powder covering on the inorganic particles. Based on a total weight of the modified inorganic powder being 100 wt %, a content of the tungsten sulfide powder is 0.01 wt % to 5 wt %. The inorganic powder is at least one from the group consisting of silicon dioxide, titanium dioxide, aluminum hydroxide, magnesium hydroxide, calcium carbonate, aluminum oxide, and calcined kaolin.

In one of the possible or preferred embodiments, a particle size of the inorganic powder is within a range from 0.01 micrometers to 50 micrometers. Based on a total weight of the glass fiber being 100 wt %, a content of the modified inorganic powder is 0.1 wt % to 5 wt %.

In one of the possible or preferred embodiments, the glass fiber has a maximum static friction coefficient within a range from 0.39 to 0.48.

Therefore, in the glass fiber and method for producing the same provided by the present disclosure, by virtue of “the tungsten compound sol forming process, the tungsten sulfide gel forming process, the heat treating process, the covering process, the mixing process, and the drawing process” and “the modified inorganic particles dispersed in the glass raw material,” problems with the conventional glass fiber that easily breaks during the drawing process can be effectively improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for producing glass fibers according to an embodiment of the present disclosure;

FIG. 2 is a schematic view of a glass fiber according to the embodiment of the present disclosure; and

FIG. 3 is a schematic view of a modified inorganic particle according to the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### [Method for Producing Glass Fibers]

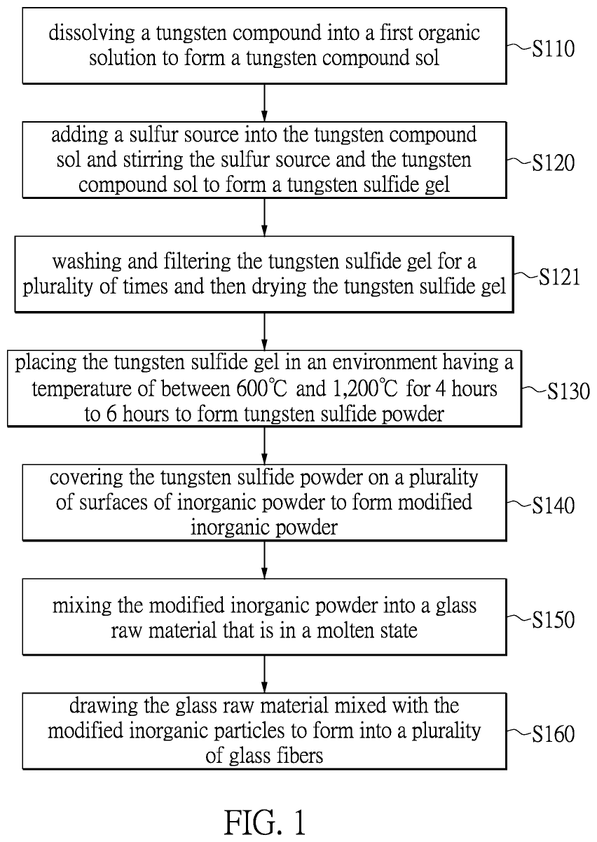

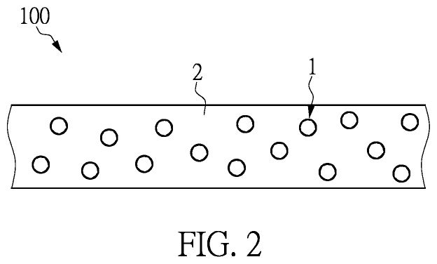

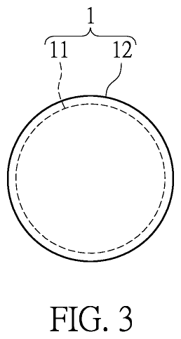

Referring to FIG. 1 to FIG. 3, FIG. 1 is a flowchart of a method for producing glass fibers according to an embodiment of the present disclosure, FIG. 2 is a schematic view of a glass fiber according to the embodiment of the present disclosure, and FIG. 3 is a schematic view of a modified inorganic particle according to the embodiment of the present disclosure. An embodiment of the present disclosure provides a method for producing glass fibers. The method includes a tungsten compound sol forming process S110, a tungsten sulfide gel forming process S120, a heat treating process S130, a covering process S140, a mixing process S1510, and a drawing process S160.

In the tungsten compound sol forming process S110, a tungsten compound is dissolved into a first organic solution to form a tungsten compound sol. In the present embodiment, the tungsten compound can be tungsten hexachloride, and the first organic solution can be ethanol or isopropyl alcohol, but the present disclosure is not limited thereto. In the tungsten compound sol forming process S110, the tungsten compound and the first organic solution are not required to be mixed or heated.

In the tungsten sulfide gel forming process S120, a sulfur source is added into the tungsten compound sol and, the sulfur source and the tungsten compound sol are stirred to form a tungsten sulfide gel. The sulfur source can be sulfur powder or hydrogen sulfide gas.

When the sulfur powder is used as the sulfur source, a weight ratio between the tungsten compound and the sulfur source can be between 5:1 and 8:1. A content of the tungsten compound can be between 400 parts by weight and 800 parts by weight, and a content of the sulfur source can be between 75 parts by weight and 115 parts by weight. Preferably, the content of the tungsten compound can be between 500 parts by weight and 700 parts by weight, and the content of the sulfur source can be between 85 parts by weight and 105 parts by weight. More preferably, the content of the tungsten compound is about 600 parts by weight, and the content of the sulfur source is about 96.8 parts by weight. In addition, a weight ratio between the tungsten compound and the first organic solution can be between 1:1.5 and 1:2.5, and a content of the first organic solution can be between 900 parts by weight and 1,500 parts by weight. Preferably, the content of the first organic solution is about 1,200 parts by weight.

After the tungsten sulfide gel forming process S120 and before the heat treating process S130, the method can further include a washing and drying process S121 implemented by washing and filtering the tungsten sulfide gel for a plurality of times and then drying the tungsten sulfide gel. Specifically, in the washing and drying process S121, a washing liquid can be used to wash the tungsten sulfide gel to remove reaction impurities and remained solution (e.g., the first organic solution). The washing liquid can be water, ethanol, or isopropyl alcohol, but the present disclosure is not limited thereto. In addition, in the washing and drying process S121, a time period and a temperature for drying the tungsten sulfide gel can be between 80° C. and 120° C. and between 1 hour to 10 hours, respectively, but the present disclosure is not limited thereto.

In the heat treating process S130, the tungsten sulfide gel is placed in an environment having a temperature of between 600° C. and 1,200° C. for 4 hours to 6 hours to form tungsten sulfide powder. The temperature and a time period of the heat treating process S130 influence a crystal structure and properties of the tungsten sulfide powder. Specifically, if the temperature is too low, the formed tungsten sulfide powder have a low conversion rate and the crystal orientation thereof is messy. The temperature of the heat treating process S130 is required to fall in a specific range, such that the crystal orientation of the formed tungsten sulfide powder is concentrated, a signal strength of a crystal surface is stronger, and the physical properties of the tungsten sulfide powder are better (e.g., better lubricity and wear resistance). The temperature of the heat treating process S130 is preferably between 650° C. and 900° C.

In addition, if the time period of the heat treating process S130 is too long, the hardness of the tungsten sulfide powder is too high, and the tungsten sulfide powder cannot easily cover onto silicon dioxide carriers. If the time period of the heat treating process S130 is too short, the formed tungsten sulfide powder have more impurities.

In addition, the heat treating process S130 can be implemented in an argon atmosphere or a nitrogen atmosphere. The argon atmosphere or the nitrogen atmosphere refers to a pure argon environment or a pure nitrogen atmosphere, and if the heat treating process S130 is not implemented in the argon atmosphere or the nitrogen atmosphere, oxygen in the environment may cause the tungsten sulfide powder to oxidize, thereby affecting the maximum static friction coefficient of a glass fiber 100.

In the covering process S140, the tungsten sulfide powder covers onto a plurality of surfaces of inorganic powder to form modified inorganic powder 1. Each of the modified inorganic particles 1 has a core-shell structure, the core-shell structure includes a core layer 11 formed by the inorganic particle and a shell layer 12 formed by the tungsten sulfide powder. Based on a total weight of the modified inorganic powder 1 being 100 wt %, a content of the tungsten sulfide powder is 0.01 wt % to 5 wt %, and a content of the inorganic particle is 95 wt % to 99.9 wt %. A particle size of each of the inorganic particle is between 0.01 micrometers and 50 micrometers.

Specifically, in the covering process S140, the tungsten sulfide powder is dispersed in a second organic solution, then the tungsten sulfide powder and the second organic solution are added into the inorganic particles, and the tungsten sulfide powder, the second organic solution, and the inorganic particles are stirred, such that the tungsten sulfide powder covers onto the inorganic particles to form the modified inorganic particles 1. More specifically, in the covering process S140, the tungsten sulfide powder is dispersed but not dissolved in the second organic solution, and the tungsten sulfide powder can be dispersed in the second organic solution through a mechanical grinding manner or an ultrasonic treatment manner, but the present disclosure is not limited thereto. In addition, the second organic solution dispersed with the tungsten sulfide powder can be dropwise added into the inorganic particles that are being stirred, and then the tungsten sulfide powder, the second organic solution, and the inorganic particles are continuously stirred and dried to form the modified inorganic particles 1.

The second organic solution can be, for example, isopropyl alcohol, and the inorganic powder is at least one from the group consisting of silicon dioxide, titanium dioxide, aluminum hydroxide, magnesium hydroxide, calcium carbonate, aluminum oxide, and calcined kaolin, but the present disclosure is not limited thereto.

In the mixing process S150, the modified inorganic powder is mixed into a glass raw material that is in a molten state. Based on a total weight of the glass raw material being 100 wt %, the glass raw material can include, for example, 54 wt % to 63 wt % of silicon dioxide, 15 wt % to 24 wt % of aluminum oxide, 6 wt % to 13 wt % of magnesium oxide, 3.4 wt % to 14 wt % of calcium oxide, 0.5 wt % to 9 wt % of boron trioxide, and 0 wt % to 7 wt % of rhenium trioxide, but the present disclosure does not limit the specific components and the content of each components included by the glass raw material 2.

In the drawing process S160, the glass raw material 2 mixed with the modified inorganic particles 1 are drawn to form into a plurality of glass fibers 100. Based on a total weight of each of the glass fibers 100 being 100 wt %, a content of the modified inorganic particles is 0.1 wt % to 5 wt %, and a content of the glass raw material 2 is 95 wt % to 99.9 wt %.

It is worth mentioning that, after the drawing process S160, the glass fibers 100 already have an excellent sliding property, and after the drawing process S160, the glass fibers 100 are not required to be added with any lubricant at the surfaces thereof. In addition, in the present disclosure, the modified inorganic particles 1 are evenly dispersed in the glass fibers 100 and are not only located at the surfaces of the glass fibers 100, such that the glass fibers 100 do not easily break during the drawing process S160.

In other words, other method for producing glass fibers in which lubricant is added after drawing process and a glass fiber that has lubricant only located at the surface thereof are not suitable to be compared to the method and the glass fiber 100 of the present disclosure. In addition, if the lubricant is only added at the surfaces of the glass fibers, the glass fibers easily break during the drawing process since an internal sliding property of the glass fibers is not enhanced.

In addition, if the tungsten sulfide powder is directly added into the glass raw material 2, the tungsten sulfide powder cannot evenly dispersed in the glass fibers 100. Accordingly, in the method of the present disclosure, the tungsten sulfide powder covers onto the surfaces of the inorganic particles to form the modified inorganic particles 1, and then the modified inorganic particles 1 are dispersed in the glass raw material 2, such that the modified inorganic particles 1 can be evenly dispersed in the glass fibers 100.

Each of the glass fibers 100 has a maximum static friction coefficient within a range from 0.39 to 0.48. In addition, it is worth mentioning that, since a melting point of tungsten sulfide is between 1,500° C. to 1,550° C., the glass fibers 100 including the modified inorganic particles 1 can have an excellent heat stability.

### [Glass Fiber]

The present disclosure further provides a glass fiber 100, the glass fiber 100 can be produced by implementing the above-mentioned method, but the present disclosure is not limited thereto. The glass fiber 100 includes a glass raw material 2 and a plurality of modified inorganic particles 1 dispersed in the glass raw material 2.

Each of the modified inorganic particles 1 has a core-shell structure, the core-shell structure includes a core layer 11 formed by the inorganic particle and a shell layer 12 formed by the tungsten sulfide powder. Based on a total weight of the modified inorganic powder 1 being 100 wt %, a content of the tungsten sulfide powder is 0.01 wt % to 5 wt %. The inorganic powder can be at least one from the group consisting of silicon dioxide, titanium dioxide, aluminum hydroxide, magnesium hydroxide, calcium carbonate, aluminum oxide, and calcined kaolin.

A particle size of each of the inorganic particle is between 0.01 micrometers and 50 micrometers. Based on a total weight of the glass fiber 100 being 100 wt %, a content of the modified inorganic powder 1 is 0.1 wt % to 5 wt %.

The glass fiber 100 has a maximum static friction coefficient within a range from 0.39 to 0.48.

### [Experimental Results]

Hereinafter, a more detailed description will be provided with reference to Exemplary Examples 1 to 3 and Comparative Example 1. However, the following Exemplary Examples are only used to aid in understanding of the present disclosure, and are not to be construed as limiting the scope of the present disclosure.

In Comparative Example 1, no modified inorganic particle is added. In the method of Exemplary Example 1 to 3, based on the total weight of the glass fiber being 100 wt %, the contents of the modified inorganic particles are 0.2 wt %, 1 wt %, and 2 wt %, respectively.

For the glass fiber produced by the method of each of Exemplary Examples 1 to 3 and Comparative Example 1, the maximum static friction coefficient, the wear resistance, and the heat stability are listed in Table 1 below. The relevant test methods are also described as follows.

A maximum static friction coefficient test is carried out by taking two test pieces each having a thickness of 5 mm and made of the glass fibers, and testing the maximum static friction coefficient of the test pieces with a friction coefficient tester (model CFT-400) under a loading condition of 200 g.

A wear resistance test is carried out by contacting a sample made of the glass fibers with a grinding wheel of a grinder and observing and grading the wear resistance of the sample.

A heat stability test is carried out by analyzing a thermal expansion coefficient of the sample made of the glass fibers with a thermal mechanical analyzer.

TABLE 1
[Maximum Static Friction Coefficient and Other Properties of
Glass Fibers of Exemplary Examples 1 to 3 and Comparative Example]

| | Comparative | Exemplary | Exemplary | Exemplary |
|---|---|---|---|---|
| Item | Example | Example 1 | Example 2 | Example 3 |
| Content of | 0 | 0.2 | 1 | 2 |
| modified | | | | |
| inorganic | | | | |
| particles | | | | |
| (wt %) | | | | |
| Maximum | 0.54 | 0.48 | 0.44 | 0.39 |
| static friction | | | | |
| coefficient of | | | | |
| glass fibers | | | | |
| Wear | 1000 | 1100 | 1200 | 1400 |
| resistance of | | | | |
| glass fibers | | | | |
| Thermal | 4 | 3.6 | 3.0 | 2.8 |
| expansion | | | | |
| coefficient | | | | |
| (10⁻⁶/)° C. | | | | |

### [Discussion of Test Results]

The more the modified inorganic particles are added, the lower the maximum static friction coefficient is, and the wear resistance is better, the product can maintain a structural integrity and an appearance quality for a longer period of time, and a life span of the product is prolonged. In a high-friction environment, the wear resistance of a glass fiber cloth made of the glass fibers can help reduce the heat generated by friction, and accordingly, excessive heating and material damage is prevented, thereby protecting the safety of the equipment and structures.

Data of the thermal expansion coefficient shows that, the more modified inorganic particles are added, the better the heat resistance is. The glass fiber cloth having a strong heat resistance can maintain the structural stability thereof at a high temperature and is not easily melted or deformed. This is important for applications that are required to maintain the shape and the strength in a high-temperature environment, such as fire insulation materials and high-temperature screening programs. Accordingly, the modified inorganic particles provided by the present disclosure can improve the physical properties of glass fibers.

### Beneficial Effects of the Embodiment

In conclusion, in the glass fiber and method for producing the same provided by the present disclosure, by virtue of “the tungsten compound sol forming process, the tungsten sulfide gel forming process, the heat treating process, the covering process, the mixing process, and the drawing process” and “the modified inorganic particles dispersed in the glass raw material,” problems with the conventional glass fiber that easily breaks during the drawing process can be effectively improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for producing glass fibers, comprising:
a tungsten compound sol forming process implemented by dissolving a tungsten compound into a first organic solution to form a tungsten compound sol;
a tungsten sulfide gel forming process implemented by adding a sulfur source into the tungsten compound sol and stirring the sulfur source and the tungsten compound sol to form a tungsten sulfide gel;
a heat treating process implemented by placing the tungsten sulfide gel in an environment having a temperature of between 600° C. and 1,200° C. for 4 hours to 6 hours to form tungsten sulfide powder;
a covering process implemented by covering the tungsten sulfide powder on a plurality of surfaces of inorganic powder to form modified inorganic powder, wherein, based on a total weight of the modified inorganic powder being 100 wt %, a content of the tungsten sulfide powder is 0.01 wt % to 5 wt %;
a mixing process implemented by mixing the modified inorganic powder into a glass raw material that is in a molten state; and
a drawing process implemented by drawing the glass raw material mixed with the modified inorganic particles to form into a plurality of glass fibers.

2. The method according to claim 1, wherein, after the tungsten sulfide gel forming process and before the heat treating process, the method further includes a washing and drying process implemented by washing and filtering the tungsten sulfide gel for a plurality of times and then drying the tungsten sulfide gel.

3. The method according to claim 1, wherein, in the covering process, the tungsten sulfide powder is dispersed in a second inorganic solution, the tungsten sulfide powder and the second organic solution are added into the inorganic powder, and then the tungsten sulfide powder, the second organic solution, and the inorganic powder are stirred, such that the tungsten sulfide powder covers onto the inorganic powder to form the modified organic powder.

4. The method according to claim 1, wherein the tungsten compound is tungsten hexachloride.

5. The method according to claim 1, wherein a weight ratio between the tungsten compound and the sulfur source is between 5:1 and 8:1.

6. The method according to claim 1, wherein the inorganic powder is at least one from the group consisting of silicon dioxide, titanium dioxide, aluminum hydroxide, magnesium hydroxide, calcium carbonate, aluminum oxide, and calcined kaolin.

7. The method according to claim 1, wherein a particle size of the inorganic powder is within a range from 0.01 micrometers to 50 micrometers.

8. The method according to claim 1, wherein, based on a total weight of each of the glass fibers being 100 wt %, a content of the modified inorganic powder is 0.1 wt % to 5 wt %.

9. The method according to claim 1, wherein each of the glass fibers has a maximum static friction coefficient within a range from 0.39 to 0.48.

10. A glass fiber, comprising:
a glass raw material; and
a plurality of modified inorganic particles dispersed in the glass raw material, wherein each of the modified inorganic particles includes a inorganic particles and tungsten sulfide powder covering on the inorganic particles, and wherein, based on a total weight of the modified inorganic powder being 100 wt %, a content of the tungsten sulfide powder is 0.01 wt % to 5 wt %,
wherein the inorganic powder is at least one from the group consisting of silicon dioxide, titanium dioxide, aluminum hydroxide, magnesium hydroxide, calcium carbonate, aluminum oxide, and calcined kaolin.

11. The glass fiber according to claim 10, wherein a particle size of the inorganic powder is within a range from 0.01 micrometers to 50 micrometers, and wherein, based on a total weight of the glass fiber being 100 wt %, a content of the modified inorganic powder is 0.1 wt % to 5 wt %.

12. The glass fiber according to claim 10, wherein the glass fiber has a maximum static friction coefficient within a range from 0.39 to 0.48.
